(19) United States
(12) Patent Application Publication
(10) Pub. No.: US 2005/0144280 A1
(43) Pub. Date: Jun. 30, 2005

(54) Load distribution system by inter-site cooperation

(75) Inventors: Tsutomu Kawai, Kawasaki (JP); Satoshi Tutiya, Kawasaki (JP); Yasuhiro Kokusho, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/050,058

(22) Filed: Feb. 4, 2005

Related U.S. Application Data
(63) Continuation of application No. PCT/JP03/03273, filed on Mar. 18, 2003.

(51) Int. Cl. G06F 15/173; G06F 15/16

(52) U.S. Cl. 709/225

(57) ABSTRACT

A system comprises a front-stage center for directly receiving a request from a client through a network, and a back-stage center for receiving the request from the client through the front-stage center. The front-stage and back-stage centers have stand-by servers, respectively. The front-stage center provides a service using a normal server. When detecting that a load on the server increases, a first system control device provides a server for providing the service the load of which increases from the stand-by server commonly provided for a first service and a second service. If the load cannot be supported even by the provision of the server, the first system control device issues an instruction to a second system control device of the back-stage center to support the provision of the service. If the back-stage control device cannot support the load using a normal server, it supports the load using the stand-by server.

### CROSS REFERENCE TO RELATED APPLICATION

This application is a continuation of an International Application No. PCT/JP03/03273, which was filed on Mar. 18, 2003.

### BACKGROUND OF THE INVENTION

1. Field of the Invention

The present invention relates to a load distribution system by inter-site co-operation.

2. Description of the Related Art

Due to the explosive popularity of the Internet, enormous resources, such as servers, networks and the like have been needed on the service providing side. It is known that the amount of their demand from users largely varies depending on time and conditions. Therefore, if such resources are secured based on the maximum demand, excessive resources must also be normally maintained. However, if resources incapable of meeting the maximum demand incur the degradation of service quality to give discomfort to users. Furthermore, with the increase of the numbers of users, it has become difficult to predict the upper limit of required resources, and a system for allocating resources as requested has become necessary. However, since excessive resources incur an increase in their management cost, a system for efficiently utilizing the excessive resources has also been necessary.

FIG. 1 shows one example of the conventional load distribution system.

In the configuration shown in FIG. 1, a client 10 accesses a data center 12 through a network 11 and receives services. A plurality of servers 14 is connected to a load distribution device 13.

If one server is not sufficient, as shown in FIG. 1, a plurality of servers is installed. In this case, a load is distributed to the plurality of servers by disposing the load distribution device 13 in the front stage to improve service quality. However, the addition determination of the server 14, the actual addition of the server 14/load distribution device 13, and design modifications must be almost made by human power. Furthermore, the maximum number of servers must be always secured. Therefore, it requires a high cost.

Patent Document 1 defines how to add servers and how to distribute requests from users. However, in that case, a mechanism for selecting a server must be incorporated on the user side, and accordingly, it is not suitable for application to a service for many and unspecified users. It has also a problem that the transmission/reception of management information other than a request is also necessary.

The method of Patent Document 2 can be applied only to the case where static information is distributed, and cannot be applied to the case where different information must be returned each time, such as service provision, depending on a request from a user.

Furthermore, Patent Document 3 also assumes static information, and the case where the load of a file server or the like becomes excessive is not considered.
Patent Document 1: Japanese Patent Application Publication No. H9-106381
Patent Document 2: Japanese Patent Application Publication No. H9-179820
Patent Document 3: Japanese Patent Application Publication No. 2002-259354

### SUMMARY OF THE INVENTION

It is an object of the present invention to provide a load distribution system for distributing a service provision load and capable of flexibly coping with the change of a request from a user.

The method of the present invention is used to distribute the load of a device provided with a plurality of servers for providing clients with services through a network. The method comprises the step of providing a plurality of stand-by servers in which no service is initially set in order to distribute the load of a server for providing normal services, and the control step of anticipating the increase in load of the servers for providing regular services, setting application for the services in the stand-by servers, specifying the plurality of stand-by servers as servers for providing the services and sharing their loads with the servers for providing regular services.

In the present invention, a plurality of stand-by servers is provided in the device of a data center or the like, in addition to the servers for providing regular services. If the load of the server for providing regular services increases, an application capable of providing such a service can be installed in a stand-by server, and the load for providing the relevant service of the server can be distributed.

In another preferred embodiment, according to the present invention, devices provided with stand-by servers are connected to a network, and stand-by servers are shared between the devices. In this case, even if one data center cannot temporarily handle its load, the interruption of service provision due to a heavy load can be avoided by coping with the load by a plurality of devices co-operating through the network. Thus, the number of stand-by servers to be provided for one device can be reduced, and accordingly, there is no need for each device to have hardware redundantly.

### BRIEF DESCRIPTION OF THE DRAWINGS

FIG. 1 shows one example of the conventional load distribution system;

FIG. 2 shows the basic configuration of the preferred embodiment of the present invention;

FIG. 3 shows the network arrangement of a center in the basic configuration shown in FIG. 2;

FIG. 4 shows the first preferred embodiment of the present invention;

FIG. 5 explains the operation of the first preferred embodiment of the present invention;

FIG. 6 shows data for calculating the load and capacity of a server;

FIG. 7 shows data for selecting a server according to the size of a load;

FIG. 8 shows the relationship between the respective predicted values of the capacity and load of an added server;

FIG. 9 shows a configuration for sharing a stand-by server with a plurality of services;

FIG. 10 shows a configuration for sharing a stand-by server with different centers;

FIG. 11 shows the operation of a preferred embodiment of the present invention;

FIG. 12 explains how to secure a network band when co-operating with another center;

FIG. 13 shows an application example of the preferred embodiment in a Web server;

FIG. 14 shows an application example of the preferred embodiment in a Web service;

FIG. 15 shows an application example of the preferred embodiment of the present invention in the case where resources are shared with equal centers;

FIG. 16 shows an application example of the preferred embodiment of the present invention in the case where a front-stage center is not provided with a stand-by server;

FIGS. 17 through 24 are flowcharts showing the operation of the preferred embodiment in the case where databases do not co-operate in a center; and

FIGS. 25 through 30 are flowcharts showing the processes of the preferred embodiment of the present invention in the case where databases are in co-operation.

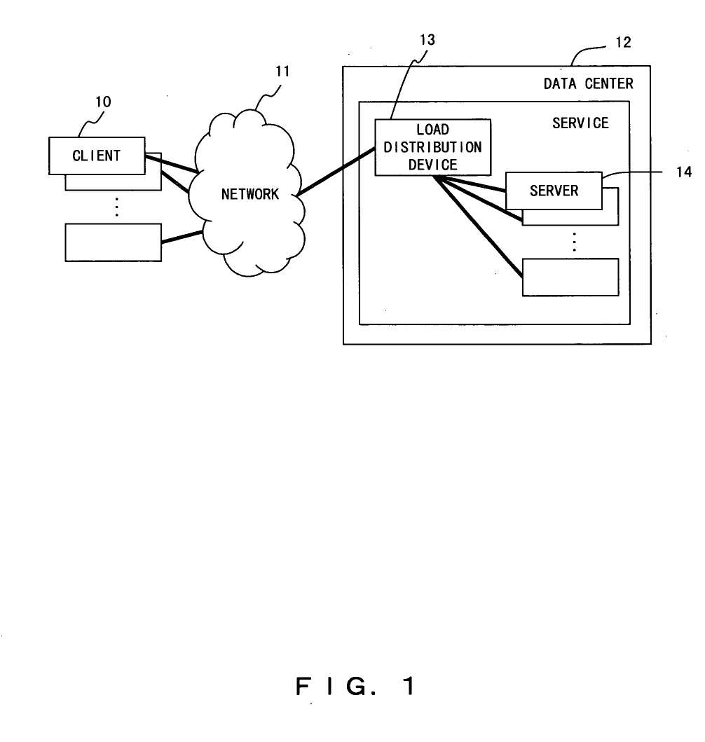

### DESCRIPTION OF THE PREFERRED EMBODIMENTS

The present invention seeks to predict a change in the amount of requests from a user, to guarantee service quality by dynamically adding and deleting servers in the same data center or a co-operation destination center, according to the prediction, and also to reduce costs by sharing surplus servers with a plurality of services.

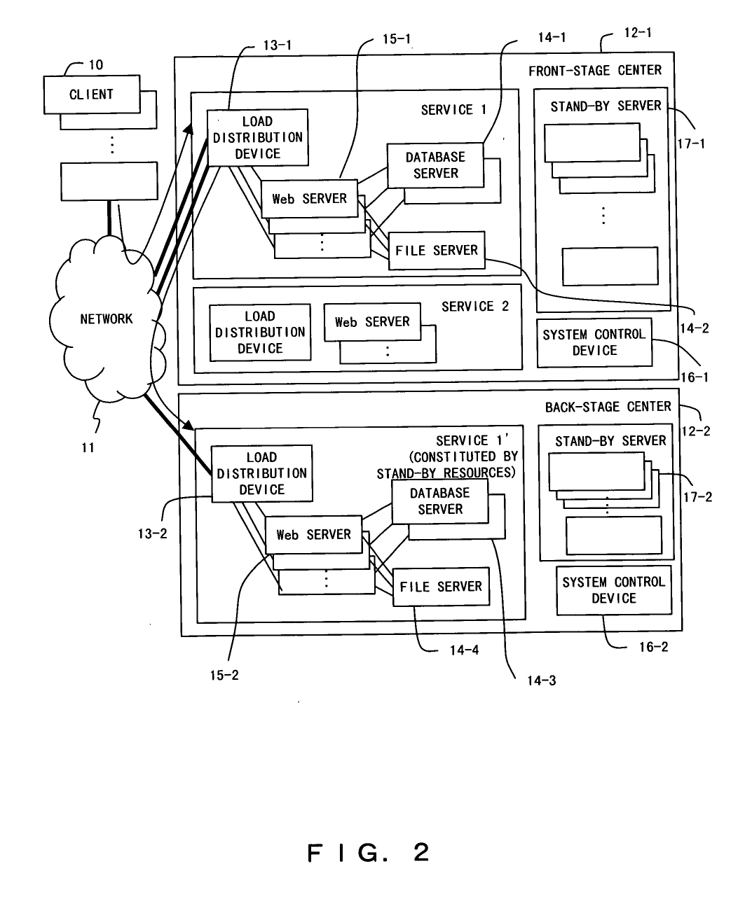

FIG. 2 shows the basic configuration of the preferred embodiment of the present invention.

A client 10 accesses a Web server 15-1 through a load distribution device 13-1 at the front-stage center 12-1 and through a network 11. In this case, according to the result of the data processing in the Web server 15-1, the client 10 accesses either a database server 14-1 or a file server 14-2, and receives a service. A back-stage center 12-2 has almost the same configuration as the front-stage center 12-1. The back-stage center 12-2 receives a request from the client 10 through the load distribution device 13-1, and leads the client 10 to a Web server 15-2 while distributing load by a load distribution device 13-2. Then, the client 10 accesses a database server 14-3 or 14-4 through the Web server 15-2 and receives the service.

In this case, the front-stage center 12-1 and the back-stage center 12-2 mean a center for directly receiving users' requests and a center for processing users' requests through the front-stage center 12-1, respectively. Servers are allocated among data centers multi-to-multi. In this case, sometimes a specific data center uses the servers of a plurality of data centers, and sometimes a specific data center simultaneously responds to server requests from a plurality of data centers. System control devices 16-1 and 16-2 total/determine/distribute the loads of servers and the loads of clients, and set the result in the servers 14-1 through 14-4 and load distribution devices 13-1 and 13-2. If server resources are insufficient, the system control devices 16-1 and 16-2 sets required functions in stand-by servers 17-1 and 17-2 and add the stand-by servers for their services. Thus, their capacity is increased.

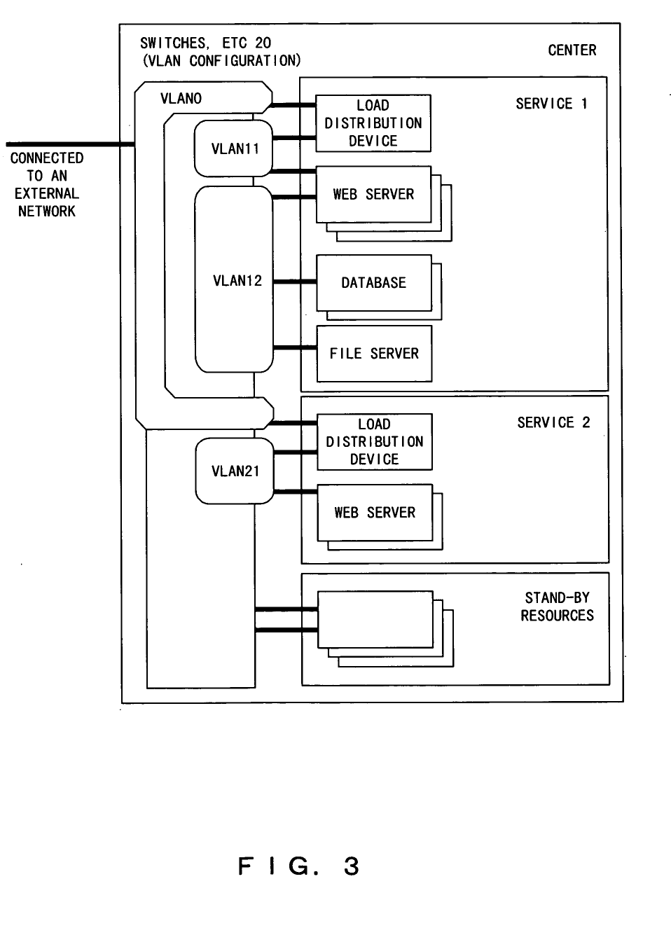

FIG. 3 shows the network arrangement of the center in the basic configuration shown in FIG. 2.

All servers are physically connected under a single switch group 20 in a network, and a plurality of logically independent networks (VLAN0, VLAN11, VLAN12 and VLAN21) is constituted. By such an arrangement, servers can be automatically added to necessary positions.

When a server is added or deleted, server capacity is calculated based on server specifications, such as a CPU function, a network configuration and the like, the required number of servers is calculated and servers are appropriately allocated. Simultaneously, the traffic of the server is calculated, and a network band is secured or arbitrated.

By estimating a future load from load measurement and load change prediction, servers can be added prior to the occurrence of an excess load, and service quality can be guaranteed.

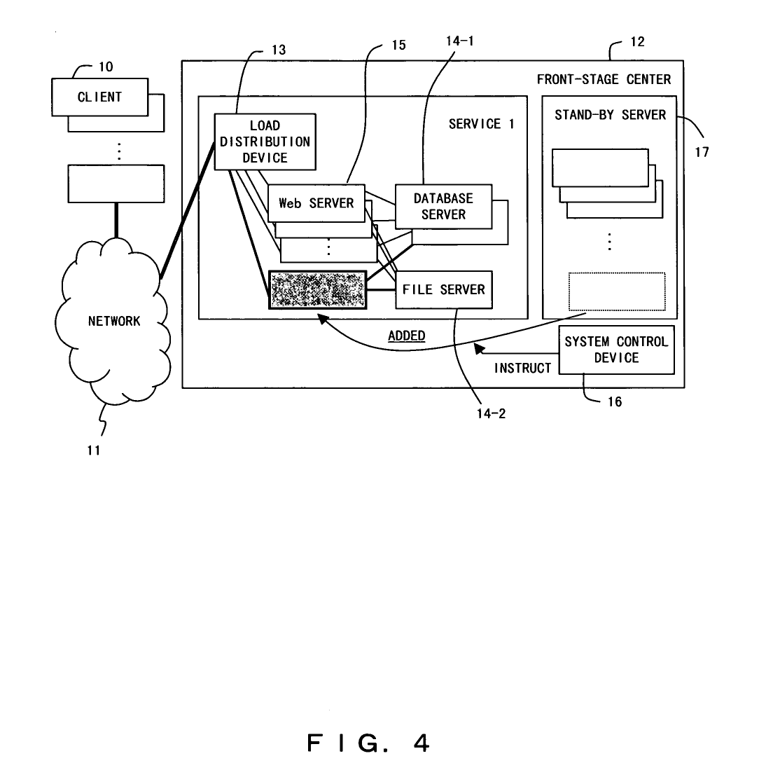

FIG. 4 shows the first preferred embodiment of the present invention.

In FIG. 4, the same reference numerals are attached to the same components as those in FIG. 2, and their detailed descriptions are omitted.

When a user's request exceeds the capacity of the allocated server, a response time increases or no response occurs to give discomfort to the user. If the load further increases in that state, sometimes a server failure occurs. In order to prevent this situation, the system control device 16 predicts the loads of servers. If it is determined that the current number of servers incurs a problem, a stand-by server 17 is added, and the setting of application, services, data to be used, and the like are set and introduced. Then, by updating the settings of dependent devices, servers and the like, they are incorporated in the service.

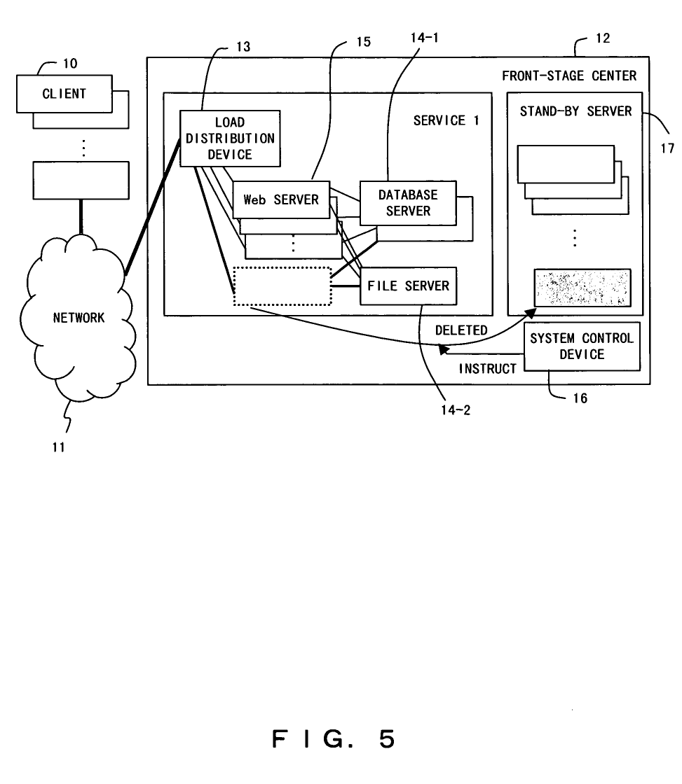

FIG. 5 explains operation of the first preferred embodiment of the present invention. In FIG. 5, the same reference numerals are attached to the same components as those in FIG. 4, and their detailed descriptions are omitted.

When the amount of requests from users decreases, a surplus server occurs. Even if this surplus server is deleted, service quality does not degrade. From the viewpoints of the improvement of a running cost and a used rate, it is rather preferable to release it as a stand-by server and to use it for another service. Thus, by deleting the related settings from the dependent devices, the link to the service is released. Then, the actual release of the settings is performed and the server is returned as a stand-by server 17.

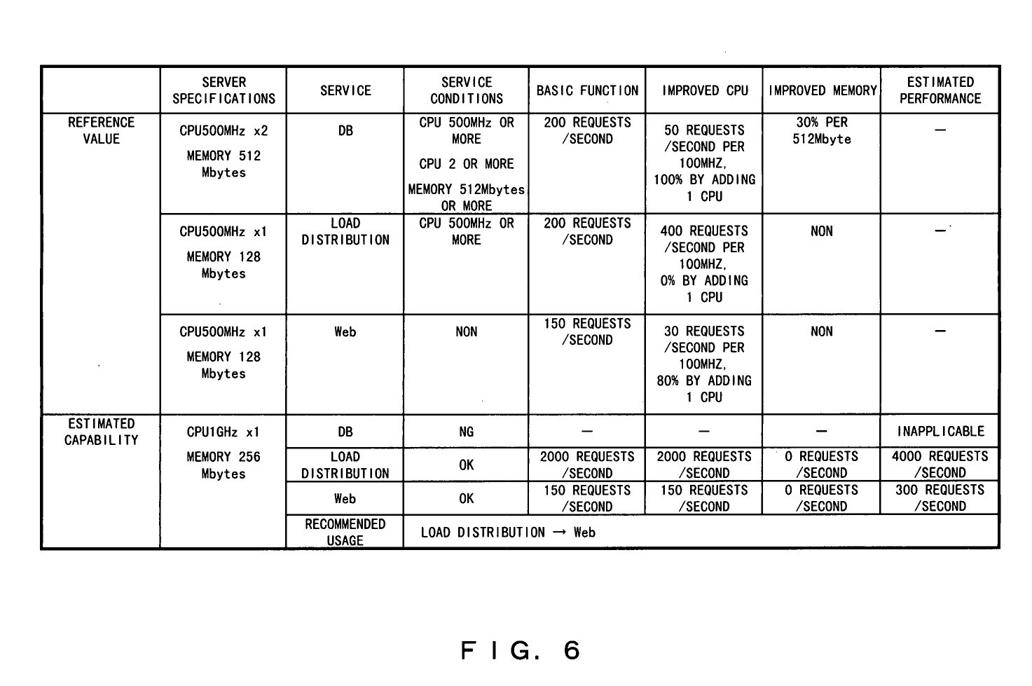

FIG. 6 shows data for calculating the load and capacity of a server.

In order to add/delete a server according to requested capacity, information about the service capacity of each server is necessary. In data centers and the like, service capacity per unit varies depending on the combination of used servers and devices, and application and services. When a plurality of data centers co-operate, it is practically impossible to prepare uniform servers. Therefore, the capacity of each server must be calculated based on the specifications of devices, such as a central processing unit (CPU), memory and the like. Thus, a method for predicting its capacity from capacity in a typical configuration, taking into consideration its CPU capacity and the like, is utilized.

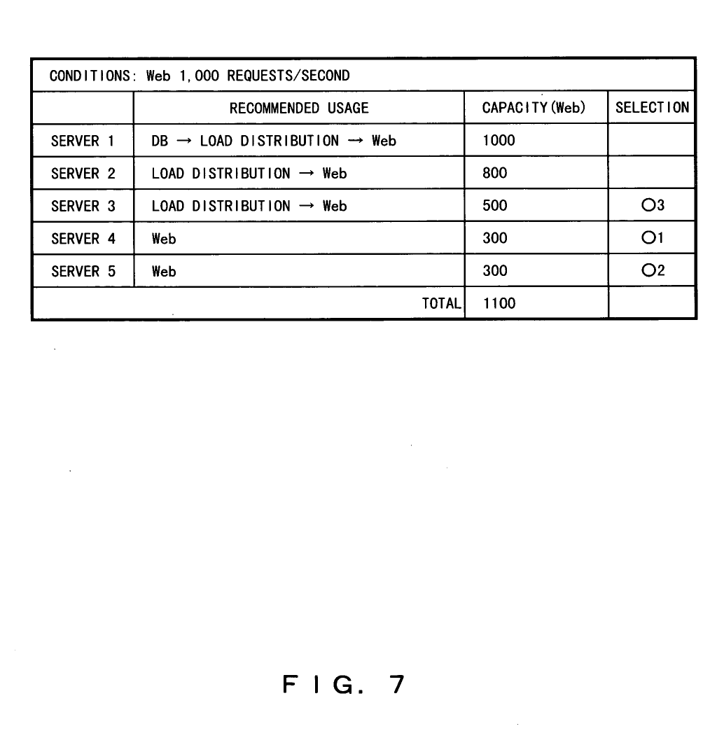

FIG. 7 shows data for selecting a server according to the size of a load.

In this case, information how to utilize each server from the viewpoint of not only its service capacity but also its characteristic is stored. As described above, since the capacity of each used server is not uniform, it is necessary to prepare a configuration so as to provide requested capacity, by combining their capacities. Thus, highly recommended servers are selected and used with priority based on the capacity and characteristic calculated in FIG. 6 and the requested capacity, until the amount of requests is satisfied.

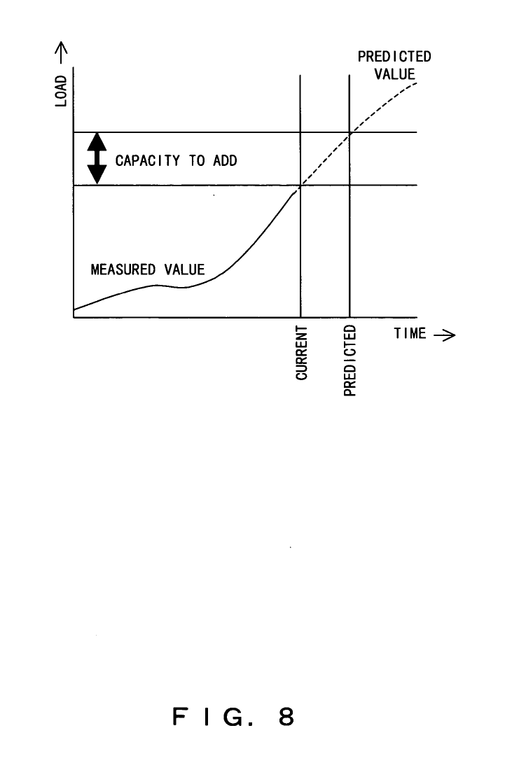

FIG. 8 shows the relationship between the respective predicted values of the capacity and load of an added server.

Only adding resources simply when the measured amount of requests exceeds the service capacity does not guarantee service quality when the load is rapidly increasing. Therefore, in order to prevent the degradation of service quality, the tendency of the load must be determined, and if the amount of requests is predicted to increase, service capacity that meets the predicted amount of requests must be added in advance. As such a prediction method, linear extrapolation or the like can be used.

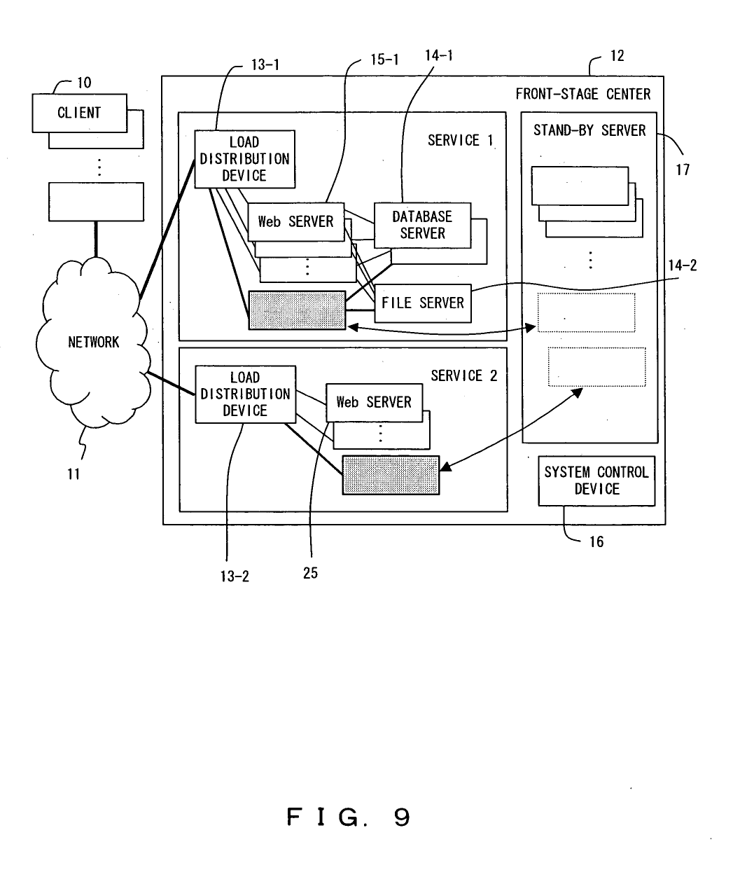

FIG. 9 shows a configuration for sharing stand-by servers with a plurality of servers. When looking at the loads of a plurality of services at a specific data center, it is very rare for all the services to have heavy loads. Therefore if stand-by resources are secured for each service, there will be always surplus resources. In this case, if stand-by resources are shared with a plurality of services, requested service capacity can be satisfied by less stand-by resources as a whole. If stand-by resources are shared with a plurality of services, its maintenance cost can also be distributed. A center 12 is installed with services 1 and 2, and the load distribution devices 13-1 and 13-2 are provided for each. The service 1 is provided further with a Web server 15-1, a database server 14-1 and a file server 14-2. The service 2 is provided with a server 25. Stand-by servers 17 are shared by the services 1 and 2, and a system control device 16 assigns a server to the service 1 or 2 according to their loads.

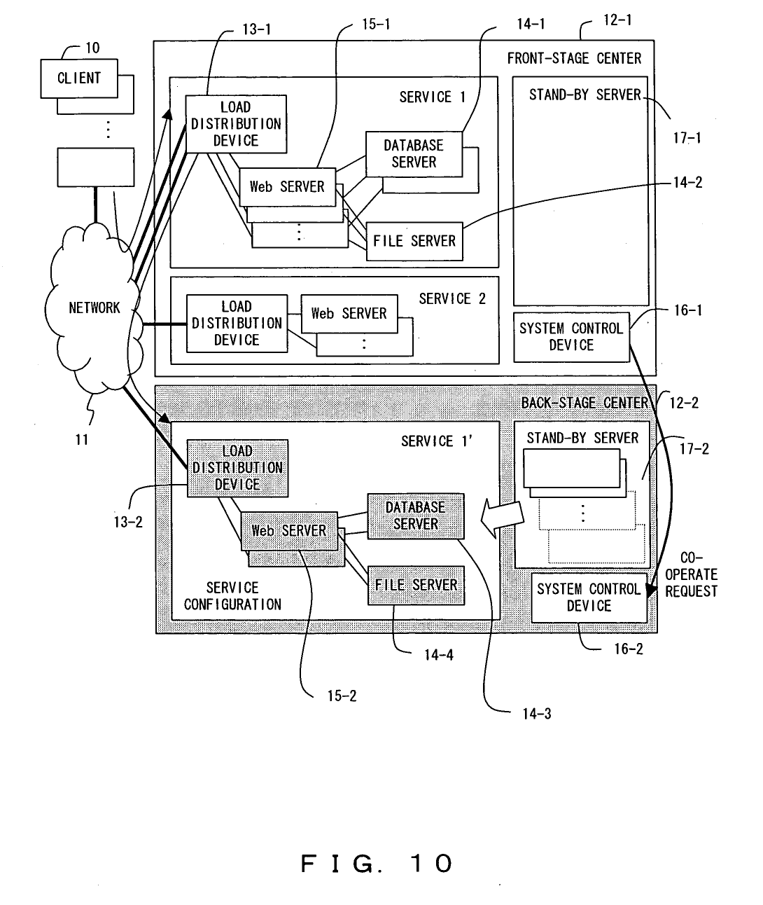

FIG. 10 shows a configuration for sharing stand-by servers with different centers. In FIG. 10, the same reference numerals are attached to the same components as those in FIG. 2, and their descriptions are omitted.

Depending on the scale of a data center 12-1, sometimes, a sufficient stand-by server 17-1 cannot be secured physically or in terms of a cost, for example, even when a stand-by server is shared by different services. Additionally, even when sufficient stand-by servers are secured, sometimes stand-by servers in the data center cannot handle a sudden load. In such a case, another data center 12-2 connected to the network can be used as a back-stage center, and its stand-by server 17-2 can be used through the network.

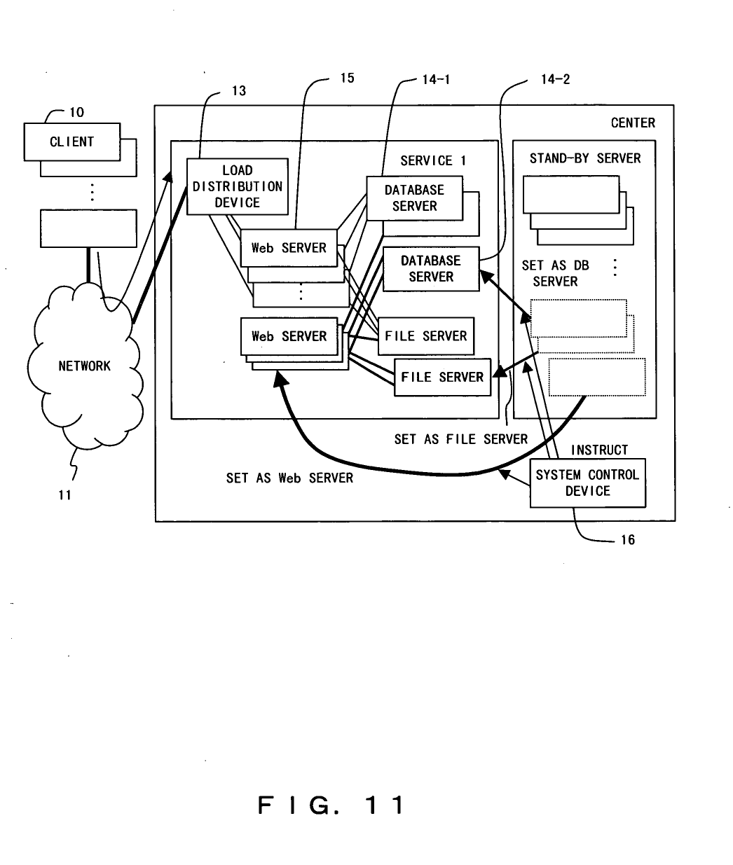

FIG. 11 shows the operation of a preferred embodiment of the present invention. In FIG. 11, the same reference numerals are attached to the same components as those in FIG. 9, and their descriptions are omitted.

A specific service requires a server for not only directly transmitting/receiving information to/from a user but also operation in co-operation with a database or the like. In the case of such a service, performance cannot be improved unless capacity and load are checked for each function and a server is added to the appropriate function. Therefore, the system control device 16 increases/reduces the capacity by checking a load for each layer and modifying the setting of a co-operation destination server when adding/deleting.

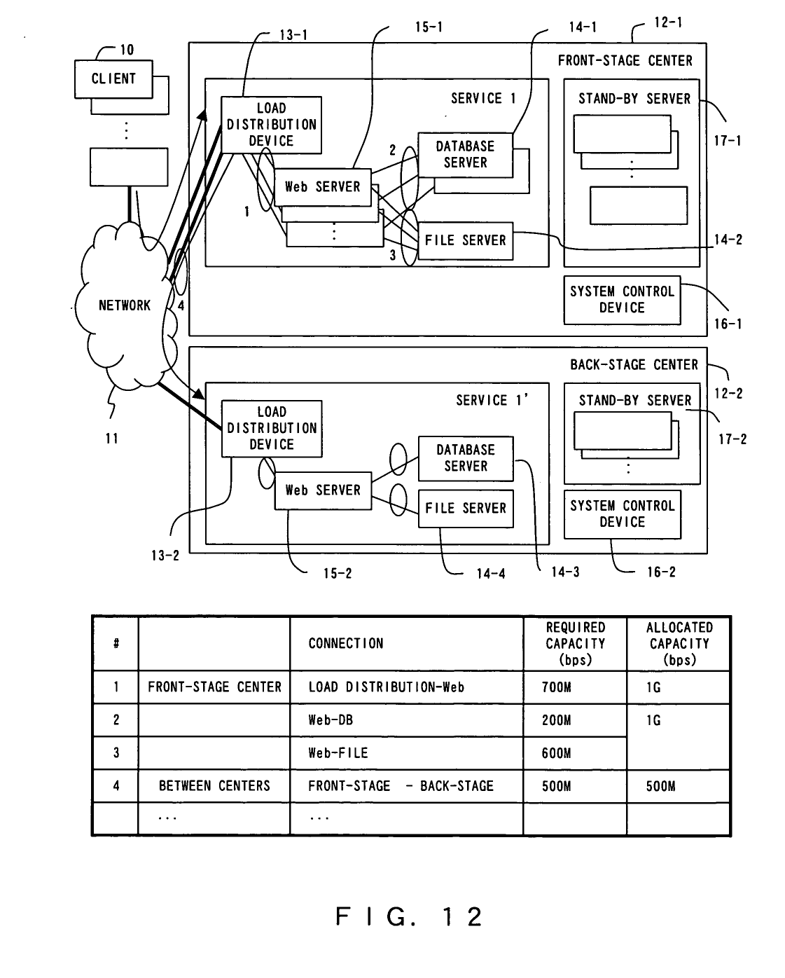

FIG. 12 explains how to secure a network band when co-operating with another center. In FIG. 12, the same reference numerals are attached to the same components as those in FIG. 10.

If a plurality of services operates simultaneously, or in co-operation is needed, in order to obtain sufficient capacity as a whole, not only a server is added, but also the traffic between services and functions must be arbitrated. In this case, a band required by each part must be calculated, and each band of the network must be secured taking its ratio into consideration.

By adopting the above-mentioned configuration, a load from a user and server capacity can be monitored, and necessary and sufficient resources can be allocated within the data center or by a co-operating data center. Accordingly, service quality can be guaranteed against a request from a user. Since simultaneously necessary stand-by servers can be widely shared, the total number of necessary servers can be reduced as a whole. Since a server can be; added to a bottlenecked function even if a service requires the co-operation of servers with a plurality of functions, its scale can be sufficiently expanded. Furthermore, the entire process can be automated, a change in the amount of requests from a user can be quickly followed.

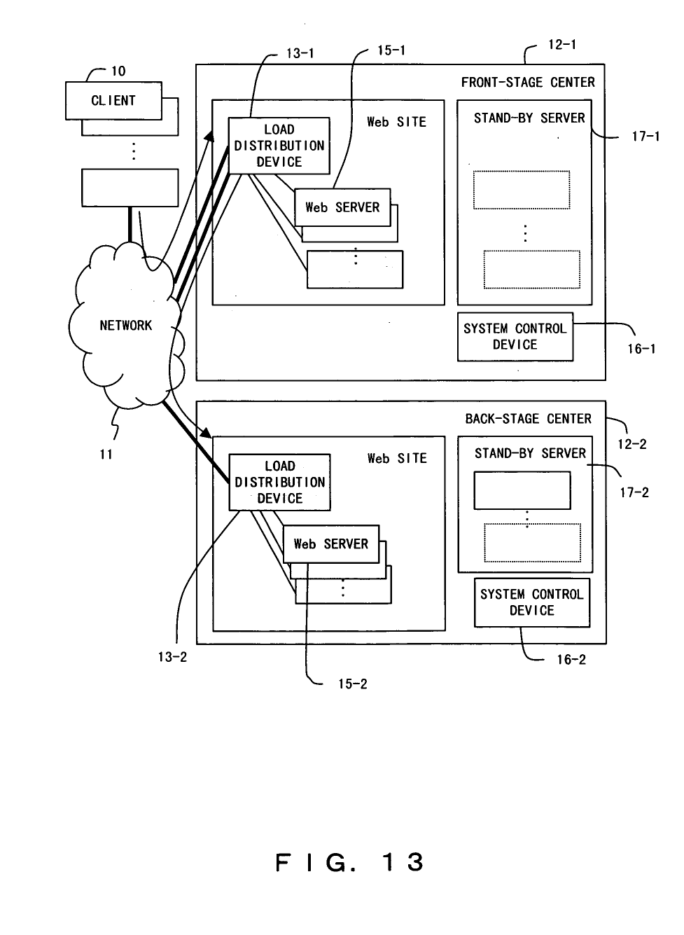

FIG. 13 shows an application example of the preferred embodiment to a Web server. In FIG. 13, the same reference numerals are attached to the same components as those in FIG. 12, and their descriptions are omitted.

In the case of a light load, only the front-stage center 12-1 handles it. When the load increases, stand-by server 17-1 in the front-stage center 12-1 is added as a Web server 15-1. When the load further increases, a Web server group 15-2 is generated in the back-stage center 12-2, and the back-stage center 12-2 also shares the load.

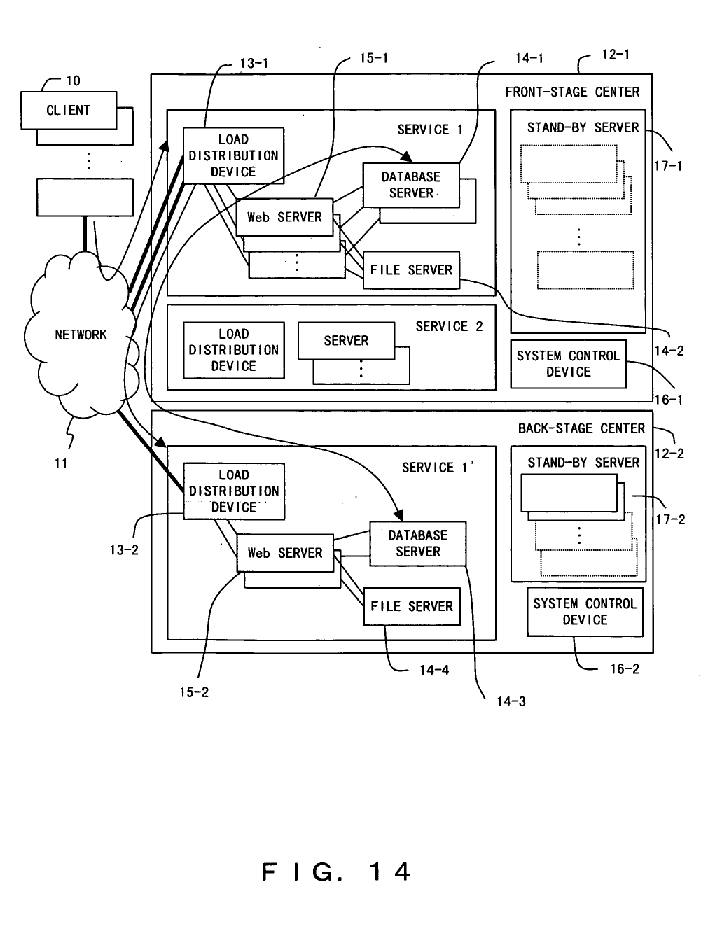

FIG. 14 shows an application example of the preferred embodiment to a Web service. In FIG. 14, the same reference numerals are attached to the same components as those in FIG. 12, and their descriptions are omitted.

In this example, a Web service is served by the combination of a Web server 15-1, a database server 14-1 and a file server 14-2. In the case of a light load, only the front-stage center 12-1 handles it. As the load increases, a stand-by server 17-1 is added to a bottlenecked part one after another. If the front-stage center 12-1 cannot handle the load alone, the back-stage center 12-2 co-operates. In this example, the database server 14-1 also synchronizes data between the front-stage center 12-1 and the back-stage center 12-2 during co-operation. This can be realized by generating VLANs crossing the centers and securing a band for them.

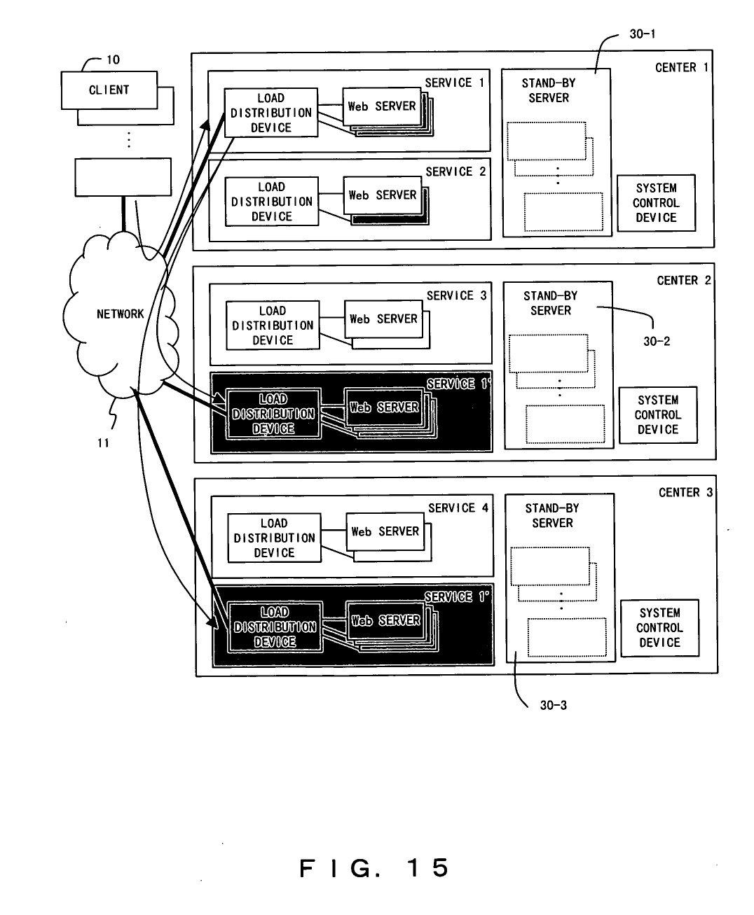

FIG. 15 shows an application example of the preferred embodiment of the present invention in the case where resources are shared by equal centers.

If the capacity of the service 1 in the center 1 together with a stand-by server 30-1 in the center 1 cannot handle the load, the center 1 requests the center 2 to co-operate and a server (a meshed portion and a stand-by server 30-2) in the center 2 is also used. If the server capacity in the center 2 cannot also handle the load (including the stand-by server 30-2), the center 1 requests another center 3 to co-operate and a server (a meshed portion and a stand-by server 30-3) in the center 3 is used.

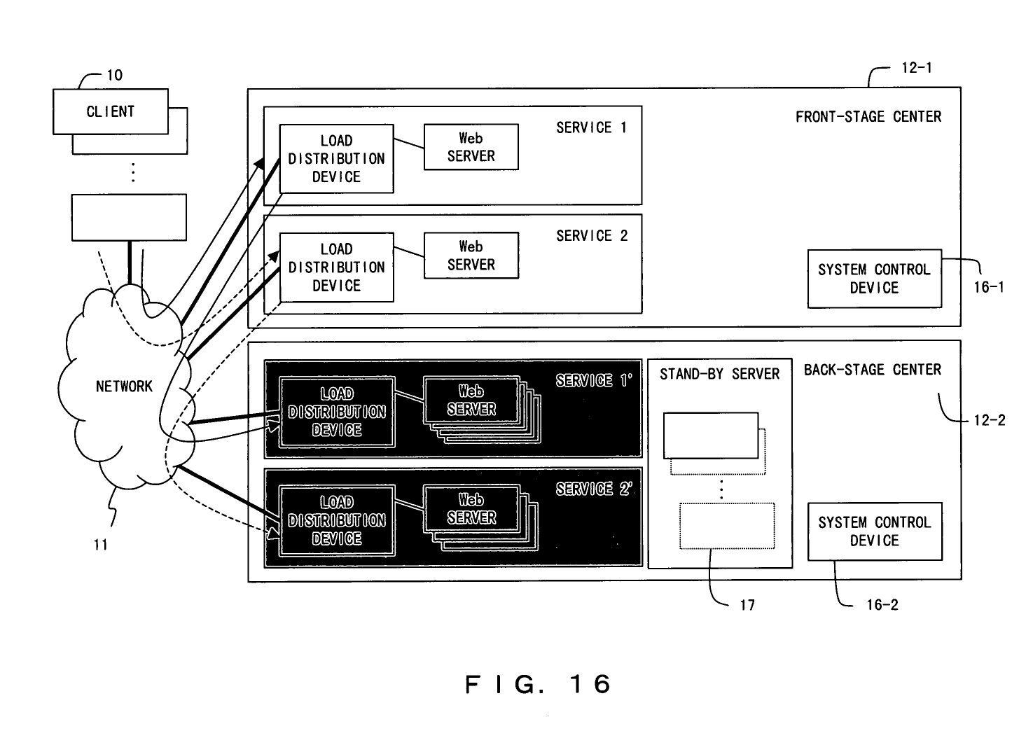

FIG. 16 shows an application example of the preferred embodiment of the present invention in the case where a front-stage center comprises no stand-by server.

If in the front-stage center 12-1, the system control unit 16-1 determines that servers are insufficient against a service provision, the front-stage center 12-1 requests the back-stage center 12-2 to co-operate and a server in the back-stage center is used. In this example, a load distribution device and a Web server are provided for the services 1 and 2, respectively. The servers of services 1′ and 2′ provide services 1 and 2, respectively. Furthermore, if in the back-stage center 12-2, server capacity is insufficient, a necessary number of stand-by servers 17 are added to each service. The determination of addition and the co-operation with the back-stage center 12-2 are made by the system control unit 16-2.

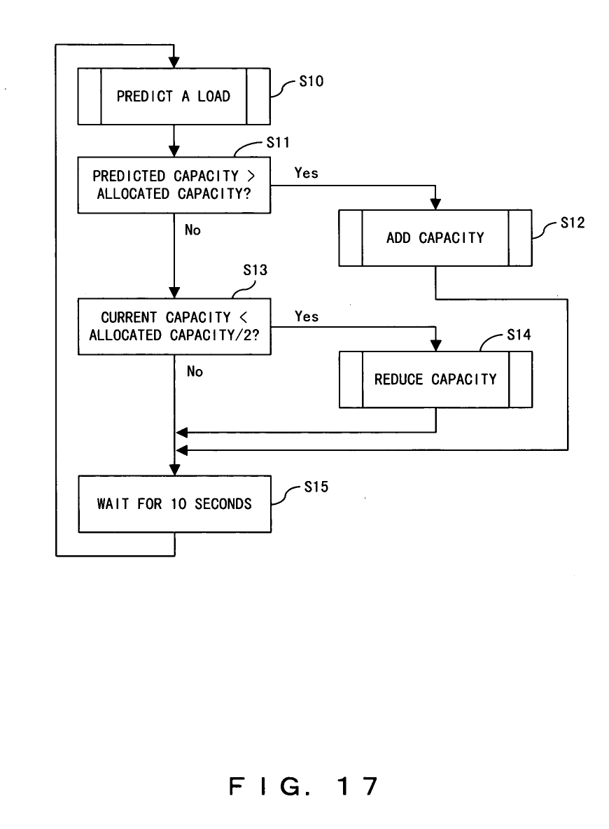

FIGS. 17 through 24 are flowcharts showing the operations of the preferred embodiment of the present invention in the case where databases installed in a center do not co-operate.

FIG. 17 is a flowchart showing the entire process of the system control device.

Firstly, in step S10, a load is measured. In step S11, it is determined whether the predicted capacity exceeds an allocated capacity. If the determination in step S11 is yes, in step S12, the capacity is added, an the process proceeds to step S15. In step S15, the process waits for 10 seconds, which a designer should design properly.

If the determination in step S11 is no, in step S13, it is determined whether the current capacity is the half or less of the allocated capacity. If the determination in step S13 is yes, in step S14, the capacity id reduced, and the process proceeds to step S15. If the determination in step S13 is no, the process proceeds to step S15.

After step S15, the process returns to step S10 again.

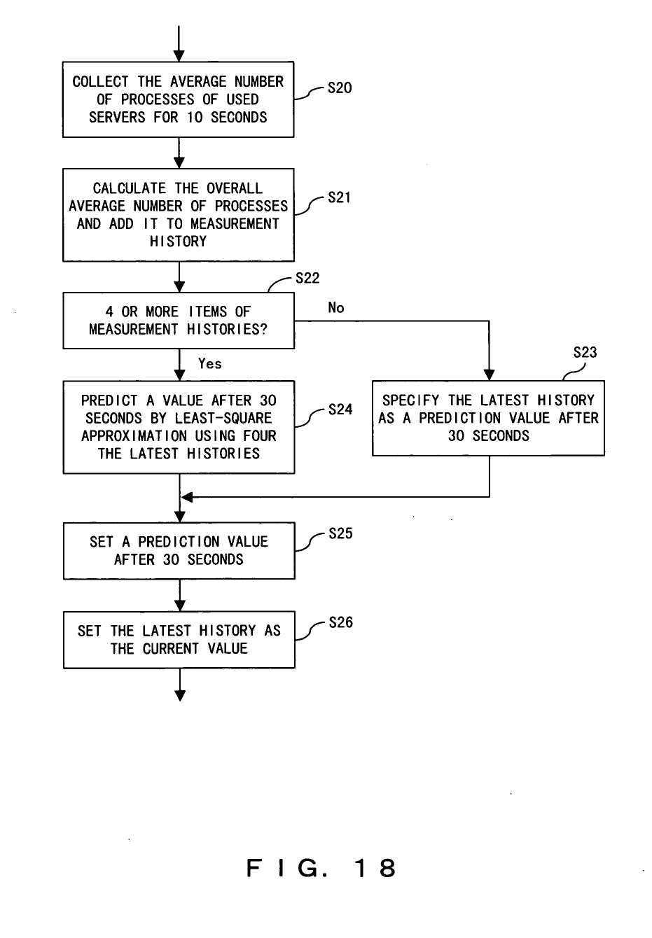

FIG. 18 shows the details of the load measurement in step S10 of FIG. 17.

In step S20, the average number of processes for 10 seconds is collected from used servers. These 10 seconds should be matched with the value in step S15 of FIG. 17. In step S21, the overall average number of processes is calculated, and is added to its measurement history. In step S22, it is determined whether there are four or more items in the measurement history. If the determination in step S22 is no, in step S23, the latest history is designated as an estimation value after 30 seconds, and the process proceeds to step S25. If the determination in step S22 is yes, in step S24, anestimation value after 30 seconds is calculated using four latest histories by least squares approximation, and the process proceeds to step S25. This means to calculate a regression curve using the four latest histories and to obtain an estimation value after 30 seconds. In step S25, the estimation value after 30 seconds is set. In step S26, the latest history is set to the current value, and the process returns to the flow shown in FIG. 17.

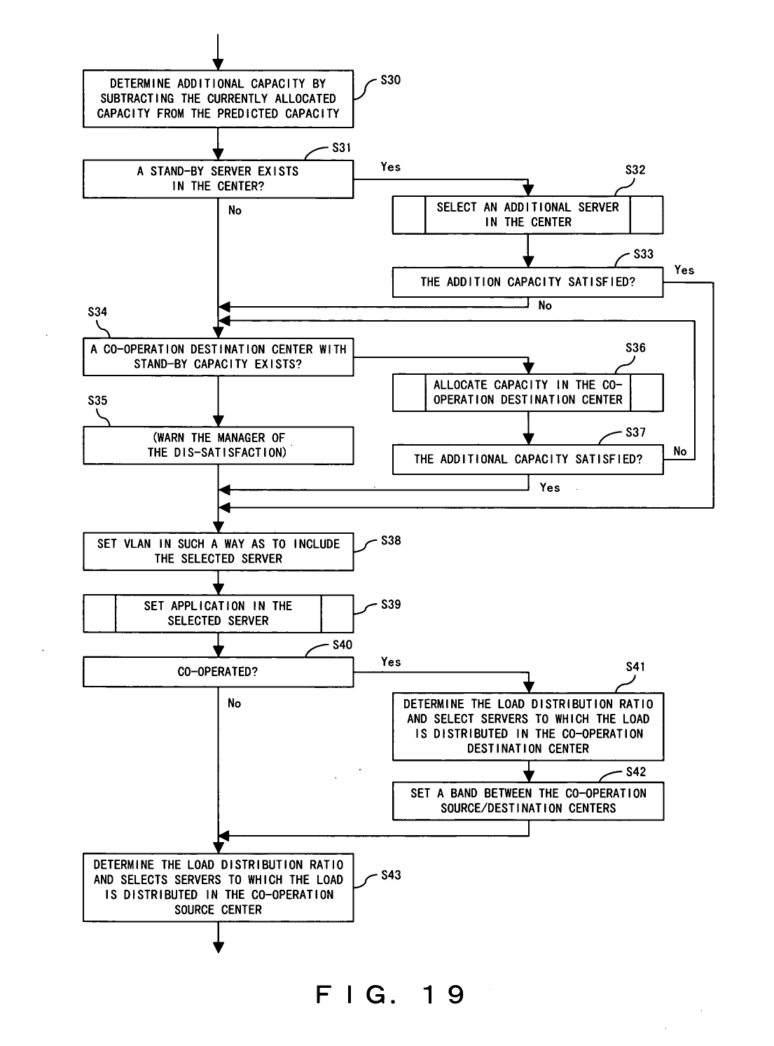

FIG. 19 the details of the capacity addition process in step S12 of FIG. 17.

In step S30, an additional capacity is obtained by subtracting the currently allocated value from the estimation value. In step S31, it is determined whether there are stand-by servers in the center. If the determination in step S31 is yes, in step S32, an addition server is selected in the center. In step S33, it is determined whether the additional capacity can be satisfied. If the determination in step S33 is no, the process proceeds to step S34. If the determination is yes, the process proceeds to step S38. If the determination in step S31 is no, the process proceeds to step S34.

In step S34, it is determined whether there is a co-operation destination center with a stand-by capacity. If the determination in step S34 is yes, in the step S36, a co-operation source center allocates capacity. In step S37, it is determined whether the additional capacity is satisfied. If the determination in step S37 is no, the process proceeds to the step S34. If the determination in step S37 is yes, the process proceeds to step S38. If the determination in step S34 is no, in step S35, the dis-satisfaction of the additional capacity is notified to a manager, and the process proceeds to the step S38. In step S38, VLANs are set in such a way as to include the selected server. In step S39, application is set in the selected server, and the process proceeds to step S40.

In step S40, it is determined whether centers are in co-operation. If the determination in step S40 is no, the process proceeds to step S43. If the determination in step S40 is yes, in step S41, the load distribution ratio of the co-operation destination center is determined and a server to which the load is distributed is selected. In step S42, a communication band is set between the co-operation source center and the co-operation destination center and the process proceeds to step S43. In step S43, the load distribution ratio of the co-operation source center is determined and servers to which the load is distributed are selected. Then, the process returns to the flow shown in FIG. 17.

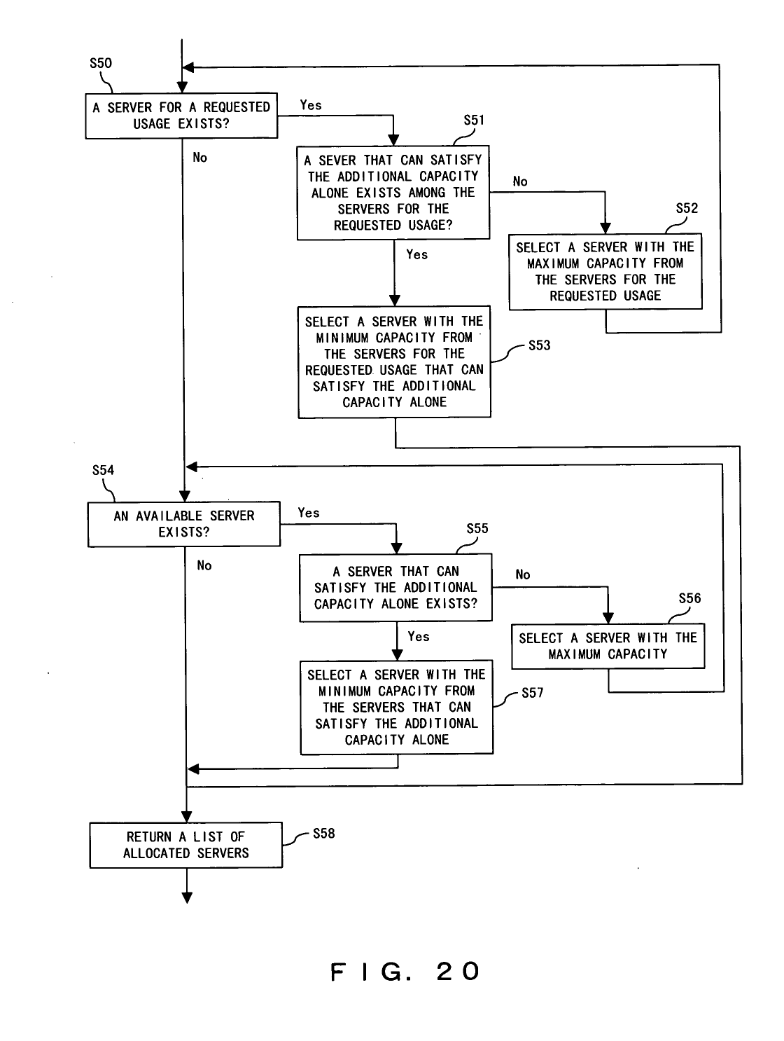

FIG. 20 shows the details of the additional server selection process in step S32 shown in FIG. 19.

In step S50, it is determined whether there is a server for a requested usage. If the determination in step S50 is no, the process proceeds to step S54. If the determination in step S50 is yes, in step S51, it is determined whether there is a server that can satisfy the additional capacity alone among the servers for the requested usage. If the determination in step S51 is no, in step S51, a server with the maximum capacity is selected from the servers for the requested usage, and the process returns to step S50. If the determination in step S51 is yes, a server with the minimum capacity is selected from servers for the requested usage that can satisfy the additional capacity, and the process proceeds to step S58.

In step S54, it is determined whether there is an available server. If the determination in step S54 is no, the process proceeds to step S58. If the determination in step S54 is yes, in step S55, it is determined whether there is a server that can satisfy the additional capacity alone. If the determination in step S55 is no, in step S56, a server with the maximum capacity is selected, and the process returns to step S54. If the determination in step S55 is yes, in step S57, a server with the minimum capacity is selected from the servers that can satisfy the additional capacity alone, and the process proceeds to step S58. In step S58, a list of allocated servers is generated, and the process returns to the flow shown in FIG. 19.

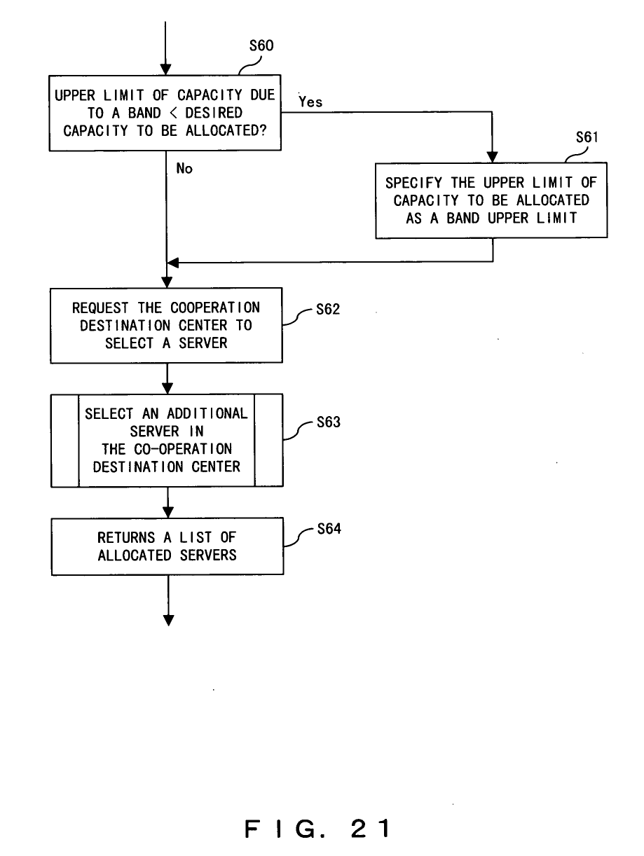

FIG. 21 shows the co-operation destination center capacity process in step S36 of FIG. 19.

In step S60, it is determined whether the upper limit of capacity due to a band is lower than desired capacity to be allocated. If the determination in step S60 is no, the process proceeds to step S62. If the determination in step S60 is yes, in step S61, the upper limit of the allocated capacity is designated as the upper limit of a band, and the process proceeds to step S62.

In step S62, the selection of the additional server is requested to the co-operation destination center. In step S63, the additional server is selected in the co-operation destination center. In step S64, a list of the allocated servers is generated, and the process returns to the flow shown in FIG. 19.

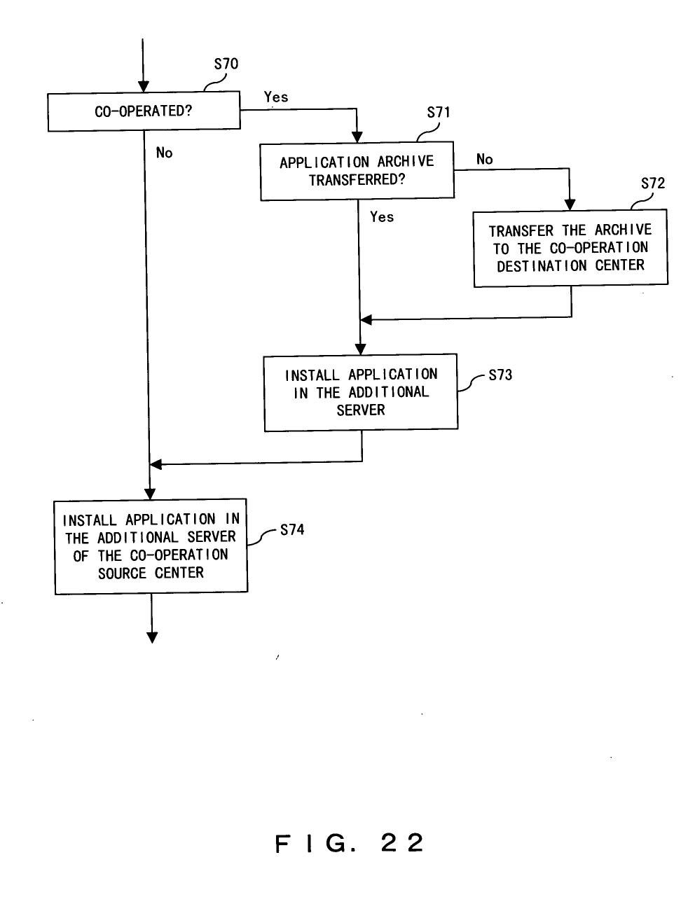

FIG. 22 shows the details of the application setting process in step S39 of FIG. 19.

In step S70, it is determined whether the centers are in co-operation. If the determination in step S70 is no, the process proceeds to step S74. If the determination in step S70 is yes, in step S71, it is determined whether application archives are already transferred. If the determination in step S71 is yes, the process proceeds to step S73. If the determination in step S70 is no, in step S72, the application archives are transferred to the co-operation destination center, and the process proceeds to step S73. In step S73, the application is installed in the additional server, and the process proceeds to step S74. In step S74, the application is installed in the additional server in the co-operation source center, and the process returns to the flow shown in FIG. 19.

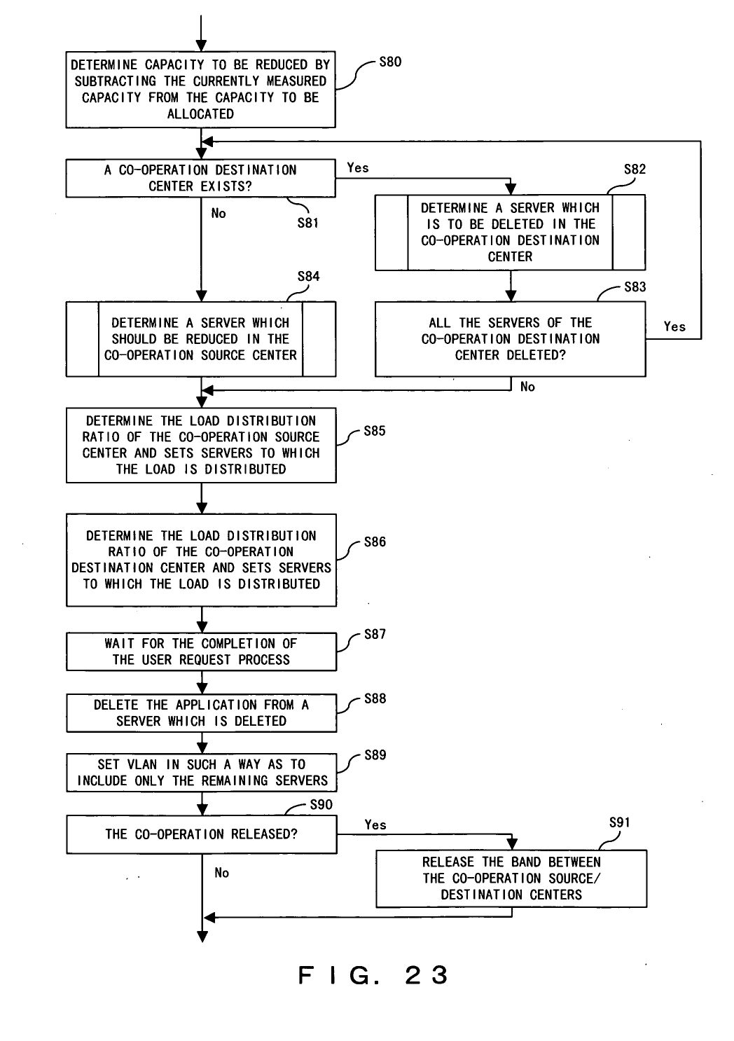

FIG. 23 shows the capacity reduction process in step S14 of FIG. 17.

In step S80, reduction capacity is determined by subtracting the current measured capacity from the allocated capacity. In step S81, there is a co-operation destination center. If the determination in step S81 is yes, in step S82, a server which should be deleted is determined in the co-operation destination server. In step S83, it is determined whether the all servers in the co-operation destination center are deleted. If the determination in step S83 is yes, the process returns to step S81. If the determination in step S83 is no, the process proceeds to step S85. If the determination in step S81 is no, in step S84, a server whose capacity is reduced is determined in the co-operation source center, and the process proceeds to step S85.

In step S85, the load distribution ratio of the co-operation source center is determined, and servers to which the load is distributed are set for operation. In step S86, the load distribution ratio of the cooperation destination center is determined, and a server to which the load is distributed is set for operation. Then, in step S87, the completion of the user request process is awaited. In step S88, application is deleted from the server which is deleted. In step S89, the VLAN is set in such a way as to include only the remaining servers (a co-operation network communication line is set). In step S90, it is determined whether the co-operation should be released. If the determination in step S90 is yes, in step S91, the band for communication between the co-operation source and destination centers, and the process returns to the flow shown in FIG. 17. If the determination in step S90 is no, the process also returns to the flow shown in FIG. 17.

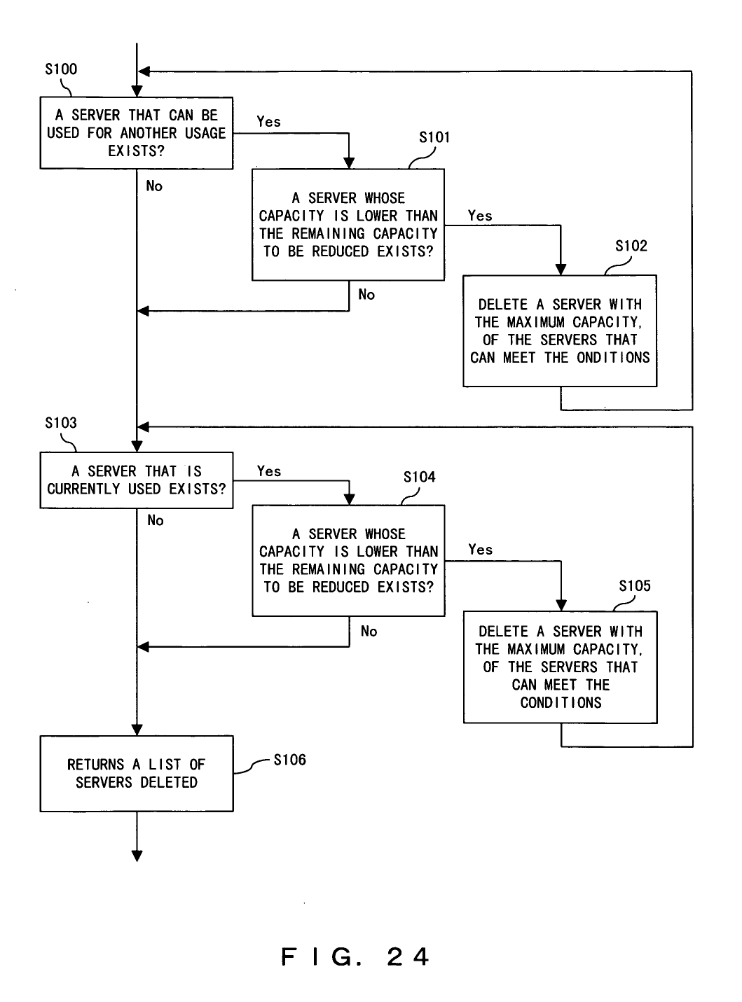

FIG. 24 shows the reduction-target server selection process in step S82 or S84 shown in FIG. 23.

In step S100, it is determined whether there is a server that can be used for another usage. If the determination in step S100 is no, the process proceeds to step S103. If the determination in step S100 is yes, in step S101, it is determined whether there is a server with capacity lower than the remaining capacity to be reduced. If the determination in step S101 is no, the process proceeds to step S103. If the determination in step S101 is yes, in step S102, the server with the maximum capacity lower than the remaining capacity to be reduced is deleted, and the process proceeds to step S100.

In step S103, it is determined whether there is a server that is currently used. If the determination in step S103 is no, the process proceeds to step S106. If the determination in step S103 is yes, in step S104, it is determined whether there is a server with capacity lower than the remaining capacity to be reduced. If the determination in step S104 is no, the process proceeds to step S106. If the determination in step S104 is yes, in step S105, a server with the maximum capacity, of the servers with capacity lower than the remaining capacity to be reduced is deleted, and the process returns to step S103.

In step S106, a list of deleted servers is generated and the process returns to the flow of FIG. 23.

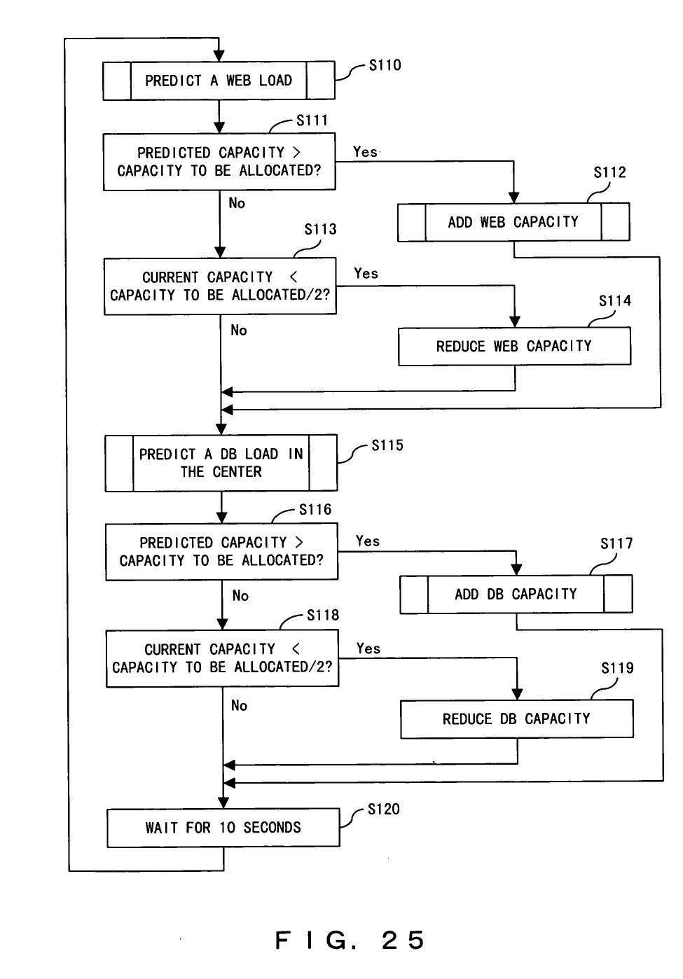

FIGS. 25 through 30 are flowcharts showing the processes of the preferred embodiment of the present invention in the case where databases are in co-operation.

FIG. 25 shows the entire process of the co-operation source center that requests for co-operation.

Instep S110, the load of a Web server is measured. In step S111, it is determined whether the predicted capacity is higher than the allocated capacity. If the determination in step S111 is yes, in step S112, the Web capacity is added, and the process proceeds to the step S115. If the determination in step S111 is no, in step S113, it is determined whether the current capacity is lower than the half of the allocated capacity. If the determination in step S113 is yes, in step S114, the Web capacity is reduced, and the process proceeds to step S115. In step S115, the load of the database in the center is predicted. In step S116, it is determined whether the predicted capacity is higher than the allocated capacity. If the determination in step S116 is yes, in step S117, the capacity of the database is added, and the process proceeds to step 120. If the determination in step S116 is no, in step S118, it is determined whether the current capacity is lower than the half of the allocated capacity. If the determination in step S116 is yes, in step S119, the capacity of the database is reduced, and the process proceeds to step S120. In step S120, the process waits for 10 seconds. A designer should properly set this waiting time. After step S120, the process returns to step S110 again.

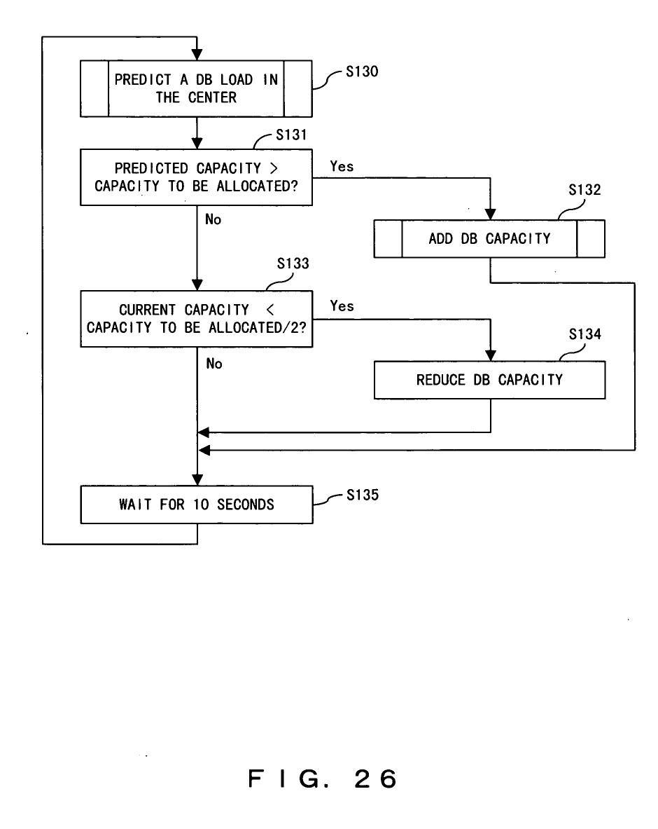

FIG. 26 shows the entire process of the co-operation destination center.

In step S130, the load of the database in the center is measured. In step S131, it is determined whether the predicted capacity is higher than the allocated capacity. If the determination in step S131 is yes, in step S132, the capacity of the database is added, and the process proceeds to step S135. If the determination in step S131 is no, in step S133, it is determined whether the current capacity is lower than the half of the allocated capacity. If the determination in step S133 is no, the process proceeds to step S135. If the determination in step S133 is yes, in step S134, the capacity of the database is reduced, and the process proceeds to step S135. In step S135, after waiting for 10 seconds, the process returns to step S130. This waiting time is not limited to 10 seconds, and a designer should properly set it.

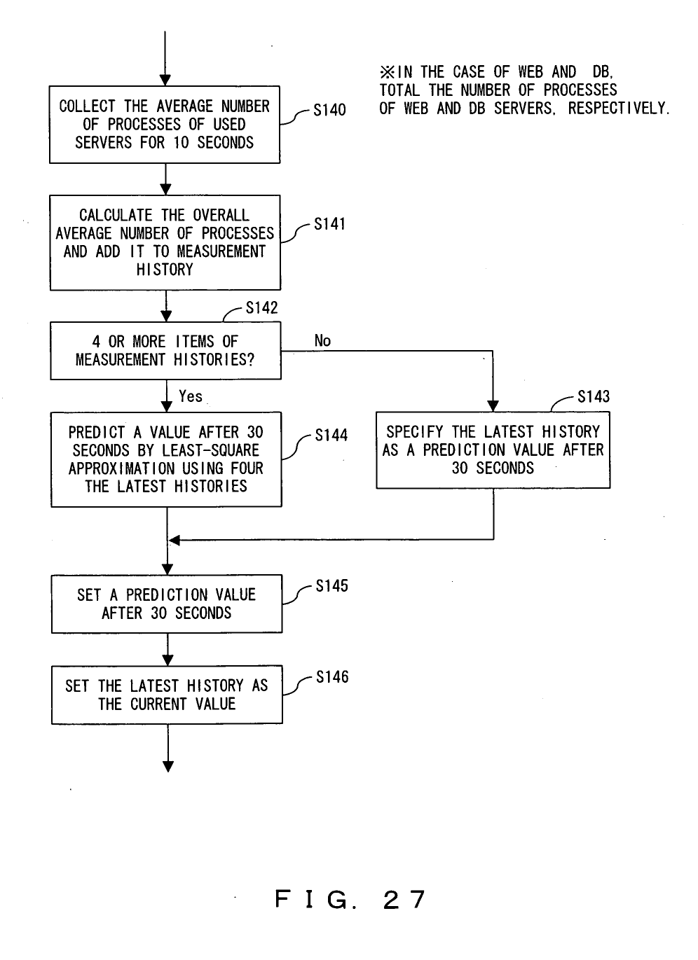

FIG. 27 shows the details of the Web/database load prediction processes in each center.

In step S140, the average number of processes for 10 seconds is collected from each used server. This time should be the same as the waiting time in step S120 of FIG. 25 and step S141 of FIG. 26. In step S141, an overall average number of processes is calculated, and is added to the measurement history. Instep 142, it is determined whether there are four or more items in the measurement history. If the determination in step S142 is no, in step 143, the latest history is designated as its prediction value after 30 seconds, and the process proceeds to step S145. If the determination in step S142 is yes, in step S144, a prediction value after 30 seconds is calculated by least squares approximation using the latest four histories, and the process proceeds to step S145. This calculation method is already described with reference to FIG. 18.

In step S145, a prediction value after 30 seconds is set. In step S146, the latest history is set as the current value, and the process returns to the flows shown in FIGS. 25 and 26.

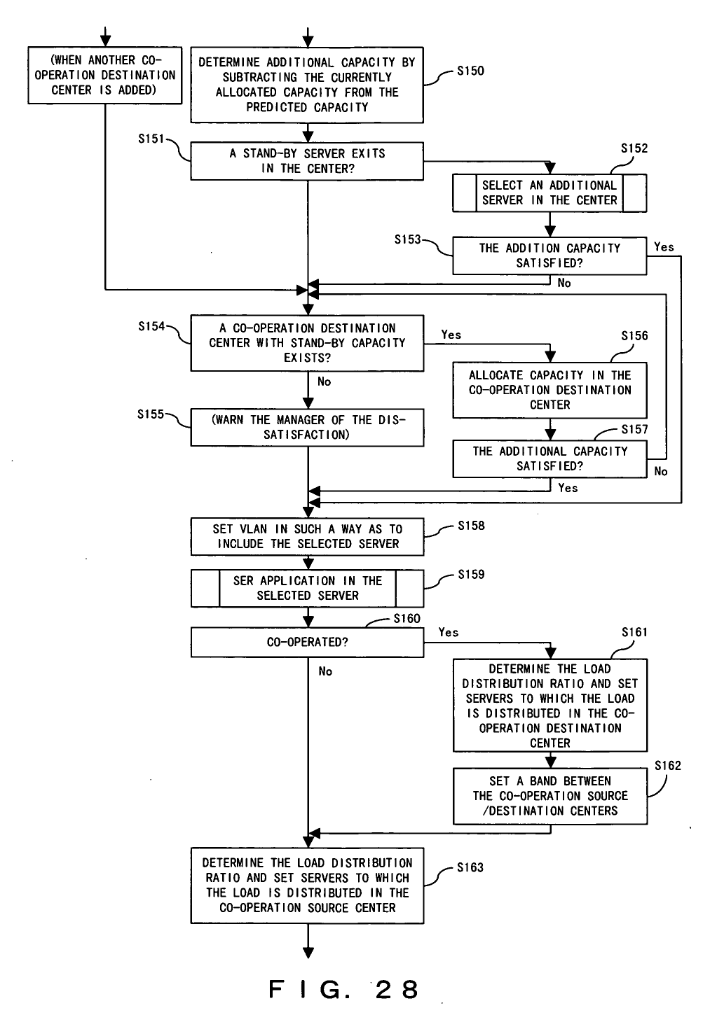

FIG. 28 shows the details of Web capacity addition process in step S112 of FIG. 25.

In the flowchart shown in FIG. 28, when another co-operation destination center is added, the process starts from step S154.

Firstly, in step S150, additional capacity is determined by subtracting the current value from the predicted value. In step S151, it is determined whether there is a stand-by server in the center. If the determination in step S151 is no, the process proceeds to step S154. If the determination in step S151 is yes, in step S152, an additional server is selected in the center. The details of this process are as shown in FIG. 20. Then, in step S153, it is determined whether the additional capacity is satisfied. If the determination in step S153 is no, the process proceeds to step S154. If the determination in step S153 is yes, the process proceeds to step S158.

In step S154, it is determined whether there is a co-operation destination center with stand-by capacity. If the determination in step S154 is yes, in step S156, capacity is allocated in the co-operation source center. The details of this process are as shown in FIG. 21. in step S157, it is determined whether the additional capacity is satisfied. If the determination in step S157 is no, the process returns to step S154. If the determination in step S157 is yes, the process proceeds to step S158. If the determination in step S154 is no, in step S155, the unsatisfactory additional capacity is notified to the manager, and the process proceeds to step S158.

In step S158, the VLAN is set in such a way as to include the selected server. In step S159, an application is set in the selected server. The setting of the application is as shown in FIG. 22. In step S160, it is determined whether the centers are in co-operation. If the determination in step S160 is yes, in step S161, the load distribution ratio of the co-operation destination center is determined, and a server to which the load is distributed is set for operation. In step S162, a communication band is set between the co-operation source and destination centers, and the process proceeds to step S163.

If the determination in step S160 is no, the process proceeds to step 163 without any process. In step S163, the load distribution ratio of the co-operation source center is determined, and servers to which the load is distributed are set for operation. Then, the process returns to the flow shown in FIG. 25.

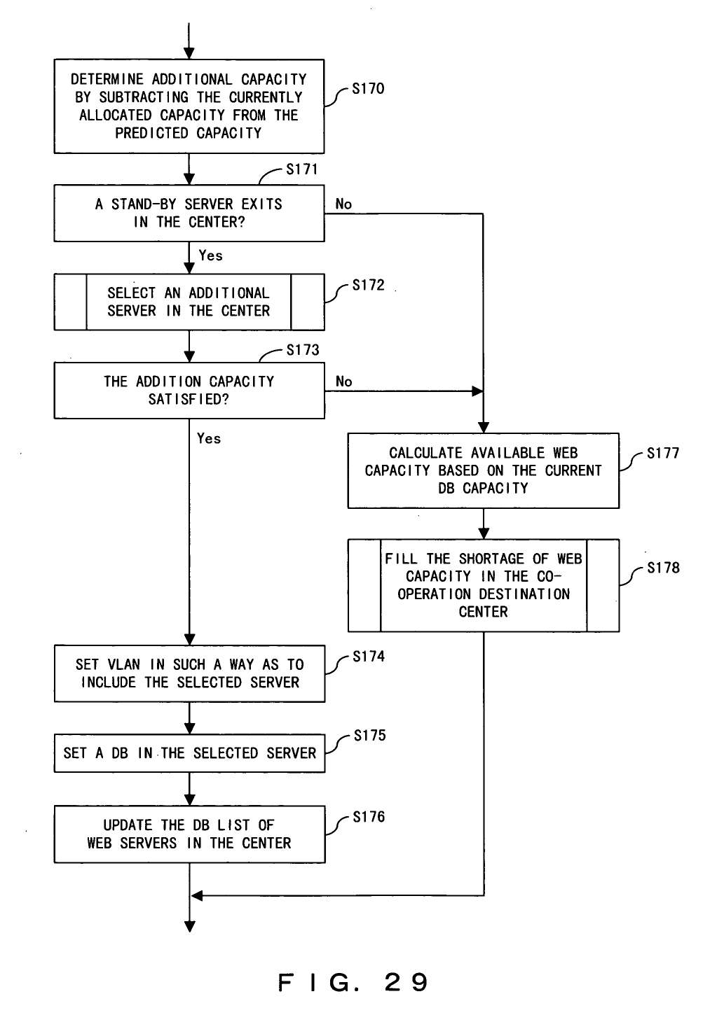

FIG. 29 shows the details of the database capacity addition process in step S117 of FIG. 25 and step S132 of FIG. 26.

In step S170, additional capacity is determined by subtracting the current value from the predicted value. In step S171, it is determined whether there is a stand-by server in the center. If the determination in step S171 is no, in step S177, available Web capacity is calculated based on the current database. In step S178, the shortage of Web capacity is filled in the co-operation destination center. The process in step S178 is as shown in FIG. 28. Then, the process returns to the flow shown in FIG. 25 or 26.

If the determination in step S171 is yes, in step S172, an additional server is selected in the center. Then, in step S173, it is determined whether the additional capacity is satisfied. If the determination in step S173 is no, the process proceeds to step S177. If the determination in step S173 is yes, in step S174, the VLAN is set in such a way as to include the selected server. In step S175, a database is set in the selected server. In step S176, the database list of the Web server in the center is updated, and the process returns the flow shown in FIG. 25 or 26.

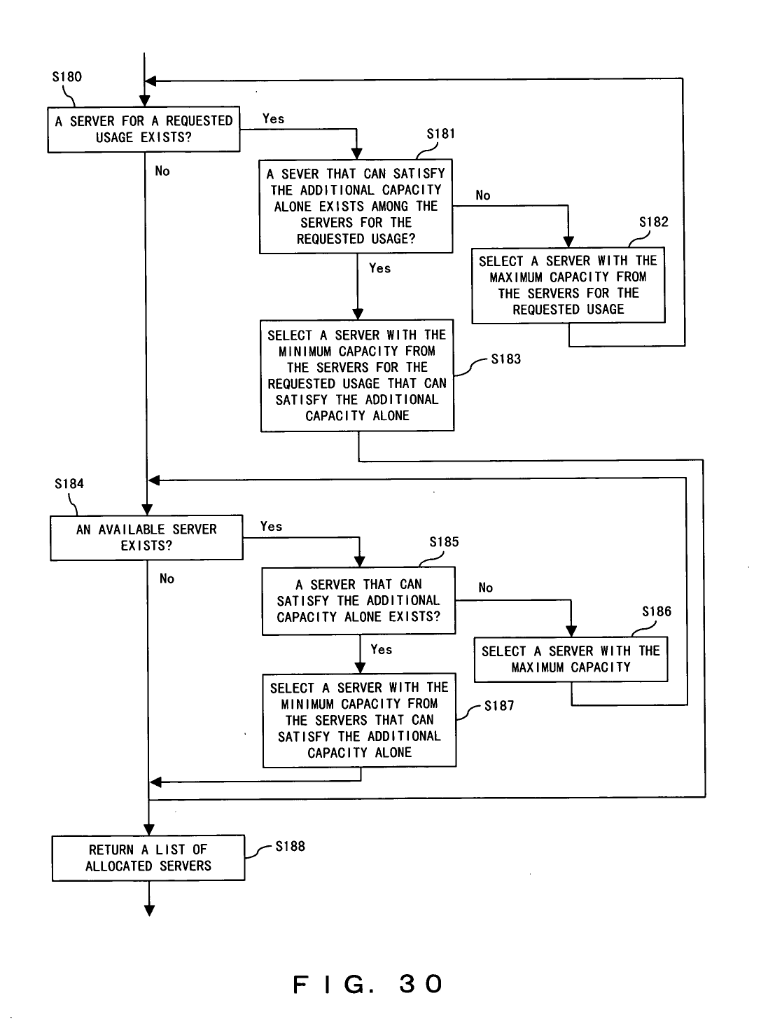

FIG. 30 shows the details of the process of selecting an additional server common to the Web server and database.

In step S180, it is determined whether there is a server for a requested usage. If the determination in step S180 is yes, in step S181, it is determined whether there is a server for the requested usage that can satisfy the additional capacity alone. If the determination in step S181 is no, in step S182, a server for the requested usage with the maximum capacity is selected, and the process returns to step S180. If the determination in step S181 is yes, a server with the minimum capacity, of the servers that can satisfy the additional capacity alone is selected, and the process proceeds to step S188.

If the determination in step S180 is no, in step S184, it is determined whether there is an available server. If the determination in step S184 is yes, in step S185, it is determined whether a server can satisfy the additional capacity alone. If the determination in step S185 is no, in step S186, a server with the maximum available capacity is selected, and the process proceeds to step S184. If the determination in step S185 is yes, in step S187, a server with the minimum capacity is selected from the servers that can satisfy the additional capacity alone, and the process proceeds to step S188. If the determination in step S184 is no, the process proceeds to step S188 without any process.

In step S188, a list of allocated servers is generated, and the process returns to the flow shown in FIG. 28 or 29.

By the present invention, high service quality can be achieved by dynamically allocating servers as requested without securing sufficient stand-by servers for each service and for each data center. Even in a small-scaled data center, service quality can be guaranteed by co-operating with another data center when a load rapidly increases and is concentrated. Furthermore, by sharing stand-by servers, facilities investment can be reduced, and also facilities can be efficiently used.

1. A load distribution method for a device provided with a plurality of servers for providing clients with services through a network, comprising:
providing a plurality of stand-by servers in which no service is initially set in order to share the loads of servers for providing regular services; and
anticipating the increase in load of the servers for providing regular services, setting application for the services provided for the stand-by servers, specifying the plurality of stand-by servers as servers for providing the services and sharing their loads with the servers for providing regular services (control step).

2. The method according to claim 1, wherein
when the plurality of said devices are connected through a network and one of the devices cannot handle the load alone, a server for providing regular services of another said device is provided for the device.

3. The method according to claim 2, wherein
the other device is provided with a stand-by server, and when the server provided for the device cannot handle the load, the stand-by server is provided.

4. The method according to claim 2, wherein
when the load is shared by the plurality of said devices, a communication band is secured between the plurality of said devices.

5. The method according to claim 1, wherein
in said control step, whether said standby server can be used to provide services is determined by predicting the size of the load after a prescribed time from the previous process number of requests from servers.

6. The method according to claim 1, wherein
when using said stand-by server for a specific service, said stand-by server suitable for providing the specific service is selected based on the hardware characteristic of said stand-by server.

7. The method according to claim 1, wherein
when using said stand-by server for a specific service, said stand-by server which can satisfy capacity to supplement alone is used with priority.

8. The method according to claim 7, wherein
a server with the minimum capacity of said stand-by servers which can satisfy the capacity to supplement alone is used with priority.

9. The method according to claim 1, wherein
if there is no stand-by server which can satisfy the capacity to supplement alone when using a stand-by server for a specific service, a stand-by server with the maximum capacity is used.

10. The method according to claim 1, wherein
in said control step, when the load is so light as to be able to satisfy without a stand-by server, the application for providing the service is deleted from the stand-by server used to provide the load which became reduced, and the use of the stand-by server is stopped.

11. The method according to claim 10, wherein
when suspending the use of a stand-by server, the use is suspended taking the hardware characteristic of the stand-by server.

12. The method according to claim 10, wherein
when suspending the use of a stand-by server, the use of a stand-by server with the maximum capacity is suspended within a range where the remaining servers including stand-by servers can handle the load of the specific service.

13. A device provided with a plurality of servers for providing clients with services through a network, comprising:
a plurality of stand-by servers in which no service is initially set in order to share the loads of servers for providing regular services; and
a control unit for anticipating the increase in load of the servers for providing regular services, setting application for the services provided for the stand-by servers, specifying the plurality of stand-by servers as servers for providing the services and sharing their loads with the servers for providing regular services.

14. A program for enabling a computer to realize a load distribution method for a device provided with a plurality of servers for providing clients with services through a network, comprising:
providing a plurality of stand-by servers in which no service is initially set in order to share the loads of servers for providing regular services; and
anticipating the increase in load of the servers for providing regular services, setting application for the services provided for the stand-by servers, specifying the plurality of stand-by servers as servers for providing the services and sharing their loads with the servers for providing regular services (control step).
